(19) United States
(12) Patent Application Publication
(10) Pub. No.: US 2002/0080089 A1
(43) Pub. Date: Jun. 27, 2002

(54) Antenna arrangement and a communication arrangement comprising the same

(76) Inventors: Leif Bergstedt, Sjomarken (SE); Spartak Gevorgian, Goteborg (SE); Thomas Lewin, Onsala (SE); Per Ligander, Goteborg (SE)

Correspondence Address: Ronald L. Grudziecki, BURNS, DOANE, SWECKER & MATHIS, L.L.P., P.O. Box 1404, Alexandria, VA, 22313-1404, US

(21) Appl. No.: 10/002,146

(22) Filed: Dec. 5, 2001

(30) Foreign Application Priority Data
Dec. 5, 2000 (SE) 0004494-1

(51) Int. Cl. H01Q 15/02; H01Q 15/24

(52) U.S. Cl. 343/909; 342/42; 342/44; 343/912

(57) ABSTRACT

The present invention relates an antenna arrangement (23, 330, 430, 530, 630) comprising a fit layer (331, 431, 531, 631) consisting of a dielectric material and a second reflective layer (335, 435, 535, 640, The dielectric material has variable dielectric characteristics. An electromagnetic radiation (50) passing through said first layer (331, 431, 531, 631) and at least partly reflected by said second layer (335, 435, 535, 640) is modulated by varying said variable dielectric characteristics of said first layer.

### TECHNICAL FIELD OF THE INVENTION

The present invention relates to a reflective antenna arrangement, specially an antenna arrangement comprising a first layer consisting of a dielectric material and a second reflective

The invention also concerns a communication arrangement comprising said antenna arrangement.

### BACKGROUND OF THE INVENTION

In U.S. Pat. No. 4,353,069, an absorptive coating for reduction of the reflective cross section of a metallic surface is provided which includes a layer of “IN” doped material adjacent the metal surface, the N doped material having a characteristic of increasing semiconductor conductivity from the outboard surface junction of the material to the boundary of the metallic surface, a second layer of “P” doped material having a characteristic of increasing semiconductor conductivity from its outboard surface boundary to its junction with the N doped material inboard of it. In the preferred embodiment, a third layer of P material is placed outboard of the second layer. The first and second layers further have electrical connections operatively associated with them, so that an applied voltage may be utilized to vary the electrical characteristics of the coating. The invention uses semiconductor p-n junction to control its resistivity under the applied electric signal (e.g. DC bias).

Disadvantages with the purposed solution are:

For large areas of the antenna the bias currents may be intolerably high

The thickness required for achievement of substantial absorption way be too large (1 inch) for practical applications, especially in onboard and/or large antennas

The speed of changing the resistivity of the absorption layer is extremely small due to the extremely small thickness of the p-n junction and hence its extremely large capacitance.

The antenna is useful for controllable absorption only. The reflected power levels are small.

In German Patent Application No. DE 43 32 042, an interference type electrically controllable reflector antenna is disclosed, which is based on an electrochemical cell with transparent conducting plates serving as mirrors for Fabry-Perot resonators This antenna is of reflective type, where the reflection coefficient is enhances due to the interferences in the Fabry-Perot etalon, where the distance between the mirrors is chosen to be λg/4 at operation frequency, f. λg is the wavelength in the Fabry-Perot etalon:

$$λ g = \frac{( {c}_{0} \sqrt{ϵ} )}{f} ,$$

where ∈ is the dielectric constant inside the etalon

Disadvantages with the proposed solution are:

The antenna is an absorptive type device, where the resistivity, hence the reflection and transmission coefficients al controlled due to the electrical control of the resistivity inside the Fabry-Perot etalon (Resonator). Due to the inherent resonant name of the Fabry-Perot etalon this antenna is narrow band, and may produce control only the amplitude of the transmission or reflected electromagnetic waves.

This device is inherently low speed due to the Red-Ox-Reaction used in the device for controlling the resistivity,

The magnitude of the control (leakage) is large, especially for large area antennas.

Other reflective anemias are known: EP 232 011 for example, discloses a Fonder, which receives signals from a reader, modulates them, and reflects them back to a reads to pass the information contained in the transponder to the reader. First conductive material is disposed on the first surface of the dielectric member at a first end of the member. Second conductive material on the second opposite surface of the dielectric member at the second end of the member defines a dipole with the first material. The second material is preferably triangular in configuration. An electrical circuitry on the dielectric member produces reflected signals modulated at a particular frequency from the signal transmitted by the reader to pass information contained in the transponder to the reader. The dipole is electrically coupled with the conductive material and enhances an impendance match between the dipole and electrical circuitry. The conductive material has a first low impendance portion split into two parts connected in parallel to provide an extended effective length in a relatively small distance, and has a second portion, preferably a “pigtail”, of substantially higher impendance than the first portion connected in series with the first portion. The first portion converts the antenna impendance to a low value and the second portion converts the low impendance to the impedance of the electrical circuitry module.

A system for discovering objects of different kinds, for finding victims of avalanches, ship wreckage etc., for warning of risky actions et., consisting of a transmitter and a transponder is disclosed in WO 92/09906. A signal emitted from the transmitter is reflected by the transponder in the form of an overtone of the emitted signal. The transponder, which can be double-sided with a reflector in-between, consists of an antenna with one or several semiconductors, a reflector and an intervening dielectricum dimensioned to give the reflected output signal maximum strength. The dielectricum can be m integral part of an article of clothing or an object

### SUMMARY OF THE INVENTION

The main object of the present invention is to provide a reflector antenna, preferably an controllable reflector antenna, which:

is based on low loss dielectric materials providing not only magnitude, but also phase/polarization control of the reflected signals with minimum absorption of the electromagnetic waves (i.e. low loss reflective antenna),

has small switching (control) time, which allows high-speed modulation of the reflected power, and hence possibility to provide a useful signal (information) on top of the reflected signals,

due to the good dielectric properties the control (leakage) currents and powers are small, which is desired for remote antennas, and antennas operating without maintenance and power supply for longer period of time.

Yet another object of the invention is to provide a communication arrangement employing an antenna according to the invention.

For these reasons, in the initially mentioned antenna arrangement said dielectric material has a variable dielectric constant. An electromagnetic radiation passing through said first layer and at least partly reflected by said second layer is modulated by varying said variable dialectic constant of said first layer.

According to one aspect of the invention the antenna arrangement further comprises a fist electrode layer, a second electrode layer, a third layer and a third electrode layer. Said first layer is a plate made of an electrically tile dielectric material. The plate consists of one of ferroelectrics, ceramics, polymers or crystallines. The first and second electrode layers are made of a material transparent to said electromagnetic radiation, allowing the radiation to pass towards the second layer. In one embodiment, the first and second electrode layers are arranged on opposite sides of said first layer. In another embodiment, the first and second electrode layers are arranged inside said first layer. Thus, a modulation signal is applied to said first and second electrode layers to changes said variable dielectric characteristics of said first layer. According to one embodiment said second layer is a plate arranged as an electromagnetic radiation sensor. The second layer at one side is provided with said second layer being a non-transparent electrode layer and at an opposite side with said th electrode layer being a parent electrode layer. The second layer has a larger thickness than said first and second electrode layers. Moreover, the third layer consists of a semiconductor plate arranged with an Schottky barrier. Thus, said third layer is abed to transform said incident electromagnetic radiation into low frequency or DC electric signals, which are extracted from said second layer and third electrode layer. According to one said first electrode layer consists of conducive strips, which reduces the capacitive coupling between the electrode layers. It is also possible to arrange said first and second electrode layers consisting of grids of elegizes comprising thin wire electrodes imbedded in said first dielectric layer, which offers reduced voltage of the modulation signal, and smaller capacitance between electrodes.

According to another aspect of the invention, said first layer is a dielectric plate mechanically attached to said second layer consisting of a metallic layer. The plate is sensitive to temperature and/or mechanical pressure. It is possible to allow temperature variations vary said dielectric characteristics of said plate. Change of said dielectric characteristics is exerted though mechanical actuation. Applying alternating forces on said plate or a frontal plate in communication with said plate could also produce the mechanical tension.

In one preferred embodiment the antenna arrangement comprises a frontal layer, which is arranged to couple electromagnetic radiation into and out of said first layer. The frontal plate has a thickness of

$$\frac{λ}{4 \sqrt{{ϵ}_{2}}} ,$$

where ∈₂=\sqrt{∈₁} is the dielectric constant of a said second (332, 432, 532), and ∈₁ is the dielectric constant of said first layer.

The invention also relates to a communication arrangement for receiving, modulating and transmitting electromagnetic radiation. The arrangement comprises a communication module, a transmitter/transreceiver, and a receiver, said communication module comprising an antenna arrangement comprising a fast layer consisting of a dielectric material and a second reflective layer. The dielectric material has a variable dielectric characteristics and an electromagnetic radiation passing through said first layer and at least partly reflected by said second layer is modulated by varying said variable dielectric characteristics of said first layer due to output signals from said electric module. The communications module mainly comprises an electronic module, a microwave senor, said antenna arrangement and a power supply unit. The electrical unit is arranged to generate low frequency modulation signals. The microwave sensor transforms an incoming electromagnetic radiation signal into low frequency or DC electric signals and transmits the signals to the electronic module.

The invention also relates to a method of modulating an incident electromagnetic radiation in an antenna arrangement comprising a first layer consisting of a dielectric material and a second reflective layer. The method comprises the steps of arranging said dielectric material with a variable dielectric characteristics and modulating said electromagnetic radiation passing through said first layer and at least partly being reflected by said secondly layer by varying said variable dielectric characteristics of said first layer.

### BRIEF DESCRIPTION OF THE DRAWINGS

In the following, the invention will be further described in a non-limiting way with reference to the accompanying drawings, in which:

FIG. 1 is a block diagram of a communication arrangement according to the invention,

FIG. 2 illustrates a more detailed block diagram of the communication arrangement of FIG. 1,

FIG. 3 is a cross-section though a section of an antenna arrangement, according to a first embodiment of the invention,

FIG. 4a is a cross-section through a section of an antenna arrangement, according to a second embodiment of the invention,

FIG. 4b is a frontal cross-section through a section of the antenna arrangement, according to FIG. 4a,

FIG. 5a is a cross-section through a part of a section of an antenna arrangement, according to a third embodiment of the invention,

FIG. 5b is a frontal cross-section through a part of the antenna arrangement, according to FIG. 5a, and

FIG. 6 is a cross-section through a section of an antenna arrangement, according to a fourth embodiment of the invention.

### DETAILED DESCRIPTION OF THE EMBODIMENTS

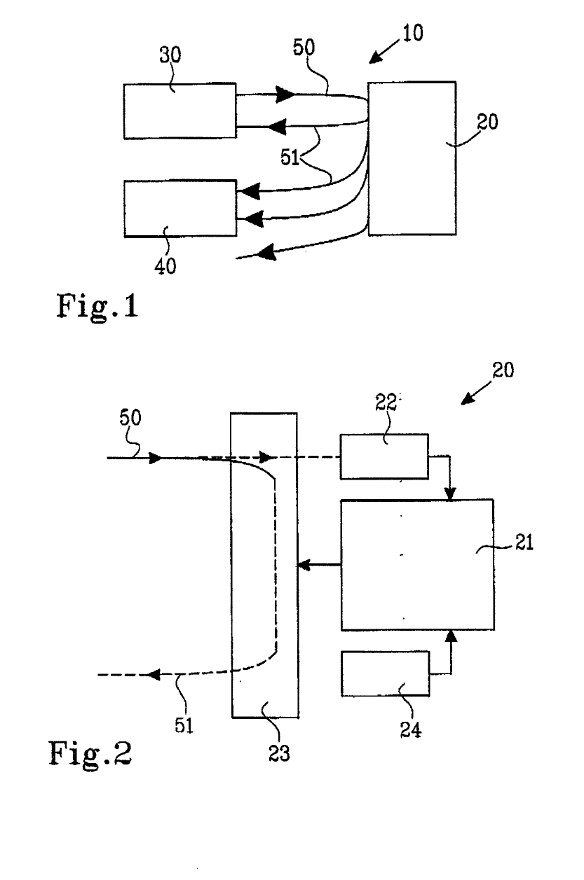

A general concept of a communications system 10, employing an arrangement according to the invention is schematically illustrated in FIG. 1. The communications system comprises a communication module 20, a transmitter/transceiver 30, and a receiver 40. A microwave carrier 50 or other electromagnetic radiation is transmitted from the (powerful) transmitter/receiver 30. The microwave carrier can be modulated or not modulated (Continues Wave, CW). A remote antenna unit (not shown) is in communication with the communications module 20. The antenna and the communication module do not contain microwave sources. Instead it uses the incident microwave power, modulates it, and reflects the microwave back to the original transmitter/receiver module or to another receiver module(s). The reflected microwave 51 can be amplitude and/or phase modulated.

The communications module 20, as shown in FIG. 2, mainly comprises an electronic module 21, a microwave sensor 22, an antenna 23 and a power supply unit 24. The electrical unit 21 contains sensors, memory etc., and it is arranged to generate low frequency modulation signals. The microwave sensor 22 transforms incoming microwave signals 50 into low frequency or DC electric signals and transmits the signals to the electronic module 21. The power supply 24 can be an along life battery for a remote module or any other suitable conventional power supply.

The key component of the arrangement, according to the invention, is the antenna. It allows modulation and reflection of the incident microwave power. It has high reflection and consumes small DC power to modulate the reflected microwave signals.

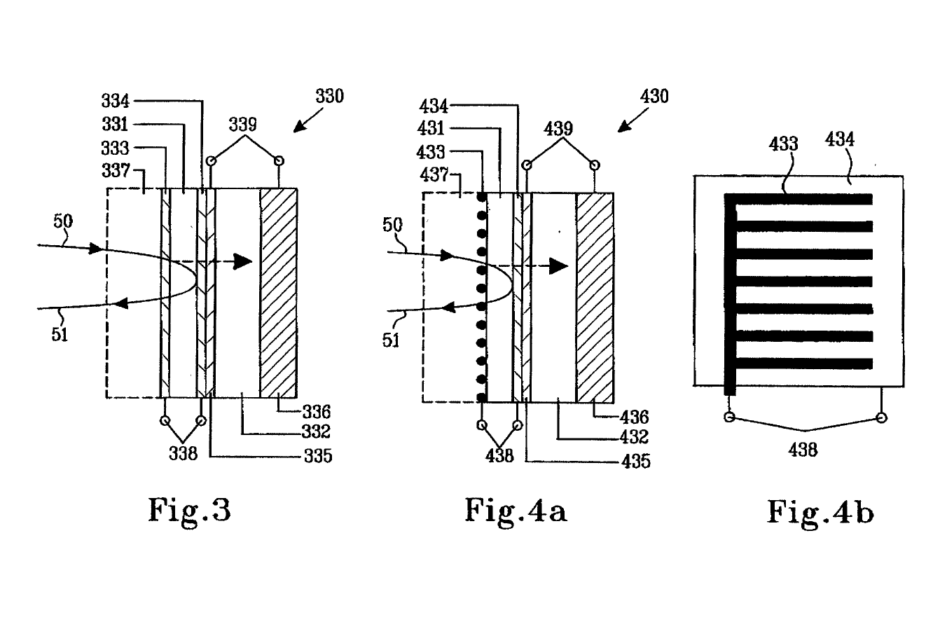

One embodiment of an antenna 330 according to the invention is illustrated in FIG. 3. The antenna 330 consist of a first layer 331, a second layer 332, a first electrode layer 333, a second electrode layer 334, a third electrode layer 335, a fourth electrode layer 336 and a frontal layer 337.

The first layer is a plate 331 arranged as a modulating plate and made of an electrically tunable dielectric material, such as ferroelectrics, ceramic, polymer or crystalline, e.g. BaTiO₃, The dielectric constant of this material is alterable (controlled) by an applied modulation sign, generated in the electronic module 21. The first and second electrode layers 333 and 334, respectively, are made of a material transparent to the microwave signals e.g. conductive, semiconducting or metal layers, with a thickness

$$δ \approx \frac{1}{\sqrt{2 π f σ }} ,$$

where ƒ is the electromagnetic radiation frequency, σ is the conductivity constant of the layer.

The modulation signal from the electronic module 21 is applied to terminals 338. The second layer is a plate 332 arranged as a microwave sensor. It is provided with a thick and to microwaves non-transparent electrode layer (fourth layer) 336 and at transparent electrode layer (third layer) 335. The third electrode layer may consist of, e.g. metal or other conductive material. The thickness, i.e. the level of non-transparency, of the third electrode layer 335 is larger than the thickness of the electrode layer 333 and 334 and it reflects most of the microwave power. Only a small portion of the power is transmitted through the electrode layer into the second layer 332. The second layer 332, which can consist of, e.g. a semiconductor plate with a Schottky barrier, transforms the microwave signals into low frequency or DC electric signals, which is extracted from terminals 339 corrected to electrodes 335 and 336, and applied to the electronic module 21. Upon appearance of an incident microwave power, the generated signals activate the electronic module 21, which generates modulation signals, i.e. useful signals that are saved and/or generated in the electronic module to be used for modulation of signals S1 transmitted back. These signals are applied to the terminals 338 connected to electrodes 333 and 334, resulting in the modulation of the dielectric constant in the plate 331. The modulation of the dialectic constant in plate 331 changes (modulates) the phase velocity of microwave signals. In other words, the reflected microwave signal is phase (and/or amplitude) modulated according to the information to be transmitted

The additional frontal layer 337 is a plate used for more efficient coupling of microwave signals in and out of the plate 331. The thickness of the plate is

$$\frac{λ}{4 \sqrt{{ϵ}_{2}}} ,$$

where ∈₂=\sqrt{∈₁} is the dielectric constant of the plate 332, and ∈₁ is the dielectric constant of the plate 331.

An alternate embodiment of an antenna 430, according to the invention, is illustrated in FIGS. 4a and 4b, wherein FIG. 4a is a section through the antenna and FIG. 4b is a frontal view through layer 437. The similar reference signs refer to some structural details as in FIG. 3. In this embodiment, the first electrode layer 433 consists of narrow conducive strips arranged to reduce the capacitance between the electrode layers 433 and 434. Hence, the time constant τ=RC of the antenna is decreased leading to increased operation speeds. This design is preferred for high-speed operation of the antenna.

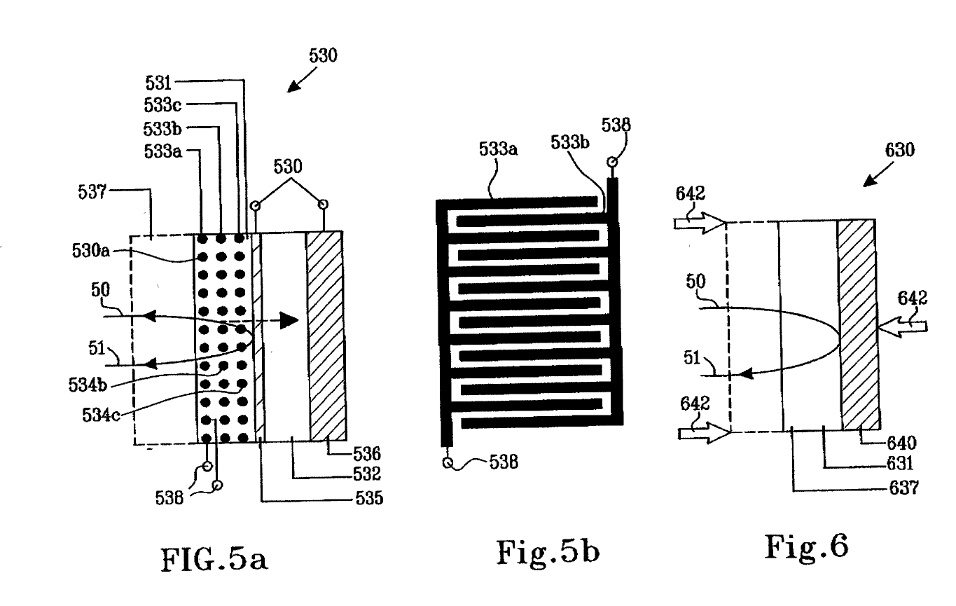

FIGS. 5a and 5b show a further modification of the antenna, denoted 530. FIG. 5a is section through the antenna and FIG. 5b is a frontal view along line through layer 537. The first and second electrode layers consist of grids of electrode layers 533a-533c and 534a-534c comprising thin wire electrodes imbedded in the dielectric layer 531. This design offers reduced voltage of the modulation signal, and smaller capacitance between electrodes 533 and 534, which results in high operation speed. FIG. 5b illustrates the electrode configuration in one of the electrode layers. Number of such electrode layers can be more than two. FIG. 5a shows an antenna 530 having three electrode layers.

Yet another embodiment of an antenna 630 is illustrated in FIG. 6, which corresponds to a very simple design of the antenna. In this embodiment no electronic or electrical components are used in the system. The antenna 630 comprises a dielectric plate 631. It is mechanically attached to a metallic layer 640. The plate 631 is sensitive to temperature, mechanical pressure (e.g. ferroelectics) or other mechanical actuations etc. Changes in the temperature, for example, will result in change in the dielectric constant of the plate 631. Additional change can be exerted, e.g. by means of mechanical tension, which appears due to the difference in thermal expansion coefficients of plate 631 and metal 640. The mechanical tension may also be produced by applying alternating forces 641 and/or 642 on the plates 631 or 637, respectively. The plate 637 is a coupling transformer, as in the previous cases. Microwave signals entered in the plate 631 will be phase modulated in accordance with the changes of the dielectric constant experienced by the plate 631 due to the changes in the temperature or mechanical pressure. Modulated microwave signals will then be reflected from the metallic plate 640 and transmitted back, carrying the modulated information.

The position of the reflecting layer is not limited to one face of the dielectric layer; it can also be placed inside the dielectric layer.

The antenna and the communication system according to the invention are particularly suitable in applications in which the system can operate without any or a special power source. Such applications may include:

Wireless computer networks in which the antenna is arranged as a part of the network transceiver card inside (or in communication with) the computer,

Part of base station transceiver in communication networks (cellular/non-cellular),

Antenna arrangement in a mobile station,

Passive communication arrangements e.g. for railroads, arranged in the railroad tracks,

Passive transponder for tracking objects,

Etc.

Especially in a wireless communication system, in which a base station is arranged to transmit with a power, the communication arrangement according to the invention can be a part of the mobile station. Consequently, the need for a power source for transmissions in the mobile station can be reduced or eliminated.

The invention is not limited to the disclosed embodiments. It can be varied in a number of ways without departing from the scope of the appended claims, and the arrangement and the method can be implemented in various ways depending on application, functional units, needs and requirements etc.

What we claim is:

1. An antenna arrangement comprising a first layer consisting of a dielectric material and a second reflective layer, where said dielectric material has variable dielectric characteristics and said first layer is arranged so that an electromagnetic radiation passing through said first layer and at least partly reflected by said second layer is modulated by varying said variable dielectric characteristics of said first layer.

2. The antenna arrangement of claim 1, wherein said antenna arrangement further comprises a first electrode layer and a second electrode layer.

3. The antenna arrangement of claim 1, where said antenna arrangement further comprises a third layer and a third electrode layer.

4. The antenna arrangement according to claim 2, wherein said first layer is a plate made of an electrically tunable dielectric material.

5. The antenna arrangement of claim 4, wherein said plate consists of one of ferroelectrics, ceramics, polymers or crystallines.

6. The antenna arrangement of claim 2, wherein said first and second electrode layers are made of a material transparent to said electromagnetic radiation.

7. The antenna arrangement of claim 2, wherein said first and second electrode layers are arranged on opposite sides of said first layer.

8. The antenna arrangement of claim 2, wherein said first and second electrode layers are arranged inside said first layer.

9. The antenna arrangement of claim 7, wherein a modulation signal is applied to said first and second electrode layers to changes said variable dielectric characteristics of said first layer.

10. The antenna arrangement of claim 3, wherein said second layer is a plate arranged as an electromagnetic radiation sensor.

11. The antenna arrangement of claim 10, wherein said second layer at one side is provided with said second layer being a non-transparent electrode layer and at an opposite side with said third electrode layer being a transparent electrode layer.

12. The antenna arrangement according to claim 2, wherein said second layer has a larger thickness than said first and second electrode layers.

13. The antenna arrangement of claim 2, wherein said third layer consists of a semiconductor plate arranged with an Schottky barrier.

14. The antenna arrangement of claim 13, wherein said third layer is arranged to transform said incident electromagnetic radiation into low frequency or DC electric signals.

15. The antenna arrangement of claim 14, wherein said signal is extracted from said second layer and third electrode layer.

16. The antenna arrangement according to claim 2, wherein said first electrode layer consists of conductive strips.

17. The antenna arrangement according to claim 2, wherein said first and second electrode layers consist of grids of electrodes comprising thin wire electrodes imbedded in said first dielectric layer.

18. The antenna arrangement according to claim 1, said first layer is a dielectric plate mechanically attached to said second layer consisting of a metallic layer.

19. The antenna arrangement according to claim 18, wherein said plate is sensitive to temperature and/or mechanical pressure.

20. The antenna arrangement according to claim 19, wherein temperature variations vary said dielectric characteristics of said plate.

21. The antenna arrangement according to claim 19, wherein change of said dielectric characteristics is exerted through mechanical actuation.

22. The antenna arrangement according to claim 21, wherein said mechanical tension is produced by applying alternating forces on said plate or a frontal plate in communication with said plate.

23. The antenna arrangement according to claim 2, wherein said antenna arrangement comprises a frontal layer, which is arranged to couple electromagnetic radiation into and out of said first layer.

24. The antenna arrangement according to claim 23, wherein said frontal plate has a thickness of:
$$\frac{λ}{4 \sqrt{{ϵ}_{2}}} ,$$
where ∈₂=\sqrt{∈₁} is the dielectric constant of a said second layer, and ∈₁ is the dielectric constant of said first layer.

25. A communication arrangement for receiving, modulating and transmitting electromagnetic radiation, wherein said arrangement comprises a communication module, a transmitter/transceiver, and a receiver, said communication module comprising an antenna arrangement comprising a first layer consisting of a dielectric material and a second reflective layer, said dielectric material having a variable dielectric characteristics and an electromagnetic radiation passing through said first layer and at least partly reflected by said second layer is modulated by varying said variable dielectric characteristics of said first layer due to output signals from said electric module.

26. The communication arrangement of claim 25, wherein said communications module mainly comprises an electronic module, a microwave sensor, said antenna arrangement and a power supply unit.

27. The communication arrangement of claim 26, wherein said electrical unit is arranged to generate low frequency modulation signals.

28. The communication arrangement of claim 26, wherein said microwave sensor transforms an incoming electromagnetic radiation signal into low frequency or DC (direct Current) electric signals and transmits the signals of electronic module.

29. The communication arrangement according to claim 25, wherein said electromagnetic radiation is a carrier wave.

30. In an antenna arrangement comprising a first layer consisting of a dielectric material and a second reflective layer, a method of modulating an incident electromagnetic radiation, wherein arranging said dielectric material with a variable dielectric characteristics and modulating said electromagnetic radiation passing through said first layer and at least partly being reflected by said second layer by varying said variable dielectric characteristics of said first layer.
